(19) United States
(12) Patent Application Publication
(10) Pub. No.: US 2007/0012526 A1
(43) Pub. Date: Jan. 18, 2007

(54) Wheelchair inboard disk brakes

(76) Inventor: Steven Holub, El Cajon, CA (US)

Correspondence Address: William C. Fuess, Suite 2G, 10951 Sorrento Valley Road, San Diego, CA, 92121, US

(21) Appl. No.: 11/184,665

(22) Filed: Jul. 18, 2005

(51) Int. Cl. B62B 5/04

(52) U.S. Cl. 188/2 F

(57) ABSTRACT

Disk brakes are located to the interior of the outermost extent of the space frame of the wheelchair, and are within the volume of this space frame, being most commonly under the seat of the occupant of the wheelchair. In this location the disk brakes are subject to unobstructed operation, and will in particular not be subject to detrimentally contacting the garments or covers of an occupant of the wheelchair. The disk brakes are preferably hydraulically actuated, and stabilized by a strut connecting two bearing blocks through each of which passes an associated axle shaft connecting to the hub of an associated wheelchair wheel at an outboard location, and also to a an associated disk brake rotor at an inboard location.

### BACKGROUND OF THE INVENTION

1. Field of the Invention

The present invention generally concerns wheelchair brakes including wheelchair disk brakes.

The present invention particularly concerns both (1) placement of wheelchair disk brakes located in positions inboard of the maximum extent of a space frame of the wheelchair; and (2) the construction of each of (2a) a wheelchair frame, (2b) wheelchair wheels and hubs and axles, and (2c) disk brakes, which in combination support location of the wheelchair disk brakes in an inboard location.

2. Description of the Prior Art

Disk brakes for wheelchairs are known in the art.

They most commonly appear on special purpose wheelchairs of custom design, especially for all terrain use and/or racing, and especially of the recumbent type. These exotic wheel chairs sometimes have a live solid axle, with, most commonly, a single disk brake mounted between the rotating axle and the frame of the chair to selectively retard the rotation of the wheels.

Wheelchairs of more conventional design where the occupant sits (s opposed to reclines) within the chair have also from time to time incorporated disk brakes. These disk brakes have been located with disk rotors affixed to the wheelchair wheels at the wheel hubs, and with the calipers affixed to the frame of the chair in positions spanning the width of each rotor. In such a position both the rotors and the calipers are substantially outside the space frame of the wheelchair, as are also the wheelchair wheels. In this specification disclosure this position is called “outboard”.

2.1 Similarities, and Differences, of the Wheelchair Disk Brake System of the Present Invention to a de Dion Vehicular Suspension

A de Dion axle is a rear axle setup developed by Count de Dion in the 19th century in which the driving wheels are attached to curved dead axle that is attached to the frame by a central pivot, a differential unit that is bolted to the frame being connected to the driving wheels by drive axles using universal joints. The De Dion system keeps the wheels upright (the same as a live axle does), but unsprung weight is reduced because the differential is out of the axle. De Dion suspension also leaves room around the differential for inboard brakes, which can further reduce unsprung weight.

The present invention will be seen to concern the location of wheel chair disk brakes in a new position (I) inboard the maximum extent of the frame of the wheelchair (ex of the wheelchair's wheels), and (ii) spaced away from the wheels by a bearing block. The present invention will also be seen to concern accompanying differences to each of the wheelchair's (a) frame, (b) wheels and hubs and axles, and ©) disk brakes themselves, in order to accommodate this “inboard” location. While the wheelchair inboard disk brakes and accompanying elements constructed in accordance with the most preferred embodiment of the present invention do not constitute either a suspension to the wheelchair, nor any sort of drive line, certain elements of the inboard disk brakes are arguably individually reminiscent of a de Dion suspension, and drive train.

Namely, in a de Dion vehicular suspension the wheels are fixedly mounted to drive shafts which are in turn supported for rotation in and by pillow blocks, or bearing surfaces. So also will the inboard disk brakes of the present invention be seen to have axle shafts—not drive, but axle, shafts—that are supported in pillow blocks. However, in a de Dion suspension these pillow blocks are affixed to the frame only though suspension elements such as springs and shock absorbers (otherwise there would be no suspension): totally unlike the inboard disk brakes of the present invention where the pillow blocks are directly affixed to the frame.

So also in the present invention will the wheels of a wheelchair be seen to affix short shafts, or axles, that are supported for rotation in and by pillow blocks, or bearing surfaces, that are affixed to the wheelchair frame. However, these shafts or axles can scarcely be called “drive shafts” because there is no drive force transmitted through, and by, these short shafts.

Furthermore, a De Dion suspension can have disk brakes located in positions between (I) the peripheral support of the drive shafts and (ii) a centrally located differential, or power transfer case, to which these drive shafts connect. In such a position the vehicle's disk brakes are described as being “inboard”, meaning that they are substantially within the rough volume roughly defined by the frame and/or body of the vehicle, and are not located, as is common in other vehicular suspensions such as the 20th century American standard Hotchkiss suspension, in “outboard” positions next to the wheels. These inboard vehicular disk brakes may have to “float” in order to accommodate movements in the drive line, and in the axle shafts, due to travel of the vehicle over the ground. They normally have to encompass that drive forces are fed along the engaged axles, and through the hubs of the disk brake rotors.

The wheelchair inboard disk brakes of present invention will again be seen to be roughly similar, in that, located in an inboard position, they serve to engage rotors. However, the disk brakes of the present invention will be seen to be opposite to those of a De Dion suspension in that they are both (I) fixedly mounted to the (wheelchair) frame, with no accommodation for “floating”, and (ii) the short shafts (to one end of which are affixed the wheels) most commonly end at, and in, the rotor hubs.

Therefore, in summary, the inboard brake system of the present invention is only superficially similar to a DeDion vehicular suspension, lacking certain elements of (I) suspension, (ii) drive and (iii) floatation generally mandatory for a DeDion vehicular suspension while preferably incorporating certain other elements such as (I) rigid pillow block mountings, and (ii) truncated short axle shafts, that are anathema to a DeDion suspension.

2.2 Prior Art Wheelchair Disk Brakes

U.S. Pat. No. 5,941,547 to Drake for a MANUALLY PROPELLED WHEELCHAIR DEVICE concerns a mechanism that, in regions of the support and connection to the wheels of a wheelchair, is roughly visually similar to some of the parts of the disk brake system of the present invention. However, this rough visual similarity—insofar as it goes, and some discerning persons may not find much similarity at all—is not even based on brakes, but is, instead, a mechanism for imparting propulsion to the wheelchair.

Namely, the wheelchair of Drake is powered by the chair occupant. Hand power levers are pivoted on each side of a chair frame. Drive cables connect each lever to a wheel pulley which in turn acts through one-way clutches to propel the wheels during the power stroke as the lever pulls the drive cable. The clutches permit free wheeling of the chair except during the application of drive power. Recoil springs rewind the cable on the pulley during the lever's return stroke. The point of cable attachment to the lever is changed by rotating the lever handle to change the ratio of lever movement to wheel movement. Moving the attachment point below the pivot point reverses the direction of the power and the return strokes. Directional control is obtained by differential application of power to the wheels and by selective wheel braking. For single hand operation, a single axle is used for both wheels. Directional control is provided by differential wheel braking with brake control levers for each wheel mounted on the single hand power lever.

U.S. Pat. No. 6,471,231 to Hargroder for an ELECTRIC BRAKE SYSTEM FOR MANUAL WHEELCHAIRS quite obviously does concern wheelchair brakes. Hargroder describes an electrical braking system is shown for a lightweight manual wheelchair. A rechargeable battery source on the wheelchair connects through a switch to a linear actuator for operation of an actuator rod. The actuator rod connects through a pulley to a single braking cable that connects to left and right caliper brakes mounted on the left and right wheels. Moving the center OFF switch a first direction will move the actuator rod, pull the braking cable, and apply both brakes. Moving the center OFF switch a second direction will move the actuator rod the opposite direction which releases the braking cable and hence the brakes. As soon as the switch returns to OFF, the linear actuator maintains the same amount of braking pressure, if any. A limit switch prevents too much braking pressure from being applied and protects the linear actuator.

Hargroder locates his disk brakes adjacent to the wheels of his wheelchair, and in a position the inventor of the present invention would describe as “outboard”. Not only will this location be seen to be opposite to the inboard location of the disk brakes of the present invention, but (I) the actuator lever of considerable (required) size, and (ii) the mechanical linkage consisting of actuator cables and rods, both contemplated by Hargroder would not readily work for the disk brakes of the present invention, which will be seen to preferably be (I) hydraulic in type (ii) using actuator levers of but modest size.

### SUMMARY OF THE INVENTION

The present invention contemplates disk brakes for a wheelchair also having axle hubs mounting wheels for rotation where each of the disk rotors, and disk calipers, are located inboard of the axle hubs.

The disk brakes are thus located to the interior of the outermost extent of the space frame of the wheelchair, and are within the volume of this space frame, and are most commonly positioned under the seat of the occupant of the wheelchair. In this location the disk brakes are subject to unobstructed operation, and will in particular not be subject to detrimentally contacting (1) the garments or covers of an occupant of the wheelchair, (2) the fabric material of any wheelchair seat, (3) the hands and fingers of the wheelchair occupant, nor (4) much of anything else, it being understood that the inboard disk brakes are visually and functionally concealed, and but poorly accessible save that the wheelchair is inverted.

1. Inboard Wheelchair Disk Brakes

Accordingly, in one of its aspects the present invention is embodied in wheelchair inboard disk brakes, being disk brakes that, in a wheelchair having a frame and wheels outboard of the frame, are mounted inboard of the frame.

In particular, in the wheelchair an axle preferably affixes each wheel while a pillow block affixed to the frame for supports each axle. Then the wheelchair inboard disk brakes preferably include a rotor affixed to each axle on the opposite side of a pillow block to where is located the wheel, and a caliper affixed to the frame and passing each rotor for selectively retarding a rotation thereof.

Each caliper is preferably hydraulically actuated, and is more preferably separately hydraulically actuated from the other caliper, permitting selective braking and directional control of the wheelchair during braking.

2. Wheelchair with Frame, Wheels, Axles, Pillow Blocks and Disk Brakes that are Inboard to the Pillow Blocks

In another of its aspects the present invention may be considered to be embodied in the special location of disk brakes in a wheelchair that is of an uncommon type having live axles as opposed to wheels rotating on fixed axles. Such a wheelchair has wheels that fixedly attach axles passing through pillow blocks affixed to the wheelchair frame in order to support rolling motion of a wheelchair—which structure and which coaction will be recognized to be opposite to a typical wheelchair where the wheels rotate about fixed axles.

In such a wheelchair the present invention is embodied in wheelchair disk brakes particularly characterized in that disk rotors and disk calipers of the disk brakes are located inboard of the axle hubs.

These disk calipers are preferably hydraulically actuated, and are more preferably separately hydraulically actuated.

3. An Improvement to the Disk Brakes of a Wheelchair

In yet another of its aspects the present invention may be considered to be embodied in an improvement to the disk brakes of a wheelchair.

The wheelchair has (I) a frame, (ii) two wheels each having a wheel hub, each wheel at its hub affixing (iii) an associated axle shaft, each axle shaft passing through (iv) an associated pillow block, each pillow block affixed to the frame of the wheelchair. Thus this wheelchair will be immediately recognized to not be of the most common type where wheels rotate on solid axles, but to instead be of a rarer type having live axles.

To this particular wheelchair the present invention constitutes an improvement where (I) a rotor is fixedly mounted to each axle shaft on an opposite side of each pillow block to where exists an associated wheel, while (ii) a caliper selectively retards rotation of each rotor, and thus a shaft to which the rotor is affixed, and thus a wheel to which the shaft is affixed.

Effectively the rotors and the calipers—which collectively constitute disk brakes—are inboard of the pillow blocks of the wheelchair, and opposite to the wheels.

Each caliper is preferably hydraulically actuated, and is more preferably separately hydraulically actuated.

These and other aspects and attributes of the present invention will become increasingly clear upon reference to the following drawings and accompanying specification.

### BRIEF DESCRIPTION OF THE DRAWINGS

Referring particularly to the drawings for the purpose of illustration only and not to limit the scope of the invention in any way, these illustrations follow:

FIG. 1 is a perspective view showing such the wheelchair inboard disk brakes of the present invention as serve to selectively apply retarding forces to each of the two axle hubs of a wheelchair.

FIG. 2 is a detail diagrammatic perspective view of a portion of the wheelchair inboard disk brakes of the present invention as serves to brake one axle hub as connects to one wheel of the two wheels of a wheelchair.

### DESCRIPTION OF THE PREFERRED EMBODIMENT

The following description is of the best mode presently contemplated for the carrying out of the invention. This description is made for the purpose of illustrating the general principles of the invention, and is not to be taken in a limiting sense. The scope of the invention is best determined by reference to the appended claims.

Although specific embodiments of the invention will now be described with reference to the drawings, it should be understood that such embodiments are by way of example only and are merely illustrative of but a small number of the many possible specific embodiments to which the principles of the invention may be applied. Various changes and modifications obvious to one skilled in the art to which the invention pertains are deemed to be within the spirit, scope and contemplation of the invention as further defined in the appended claims.

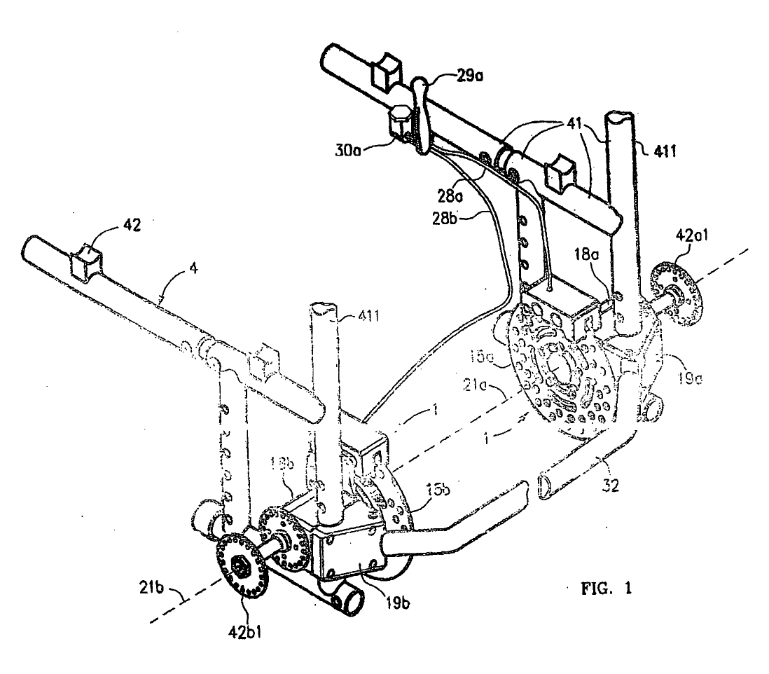

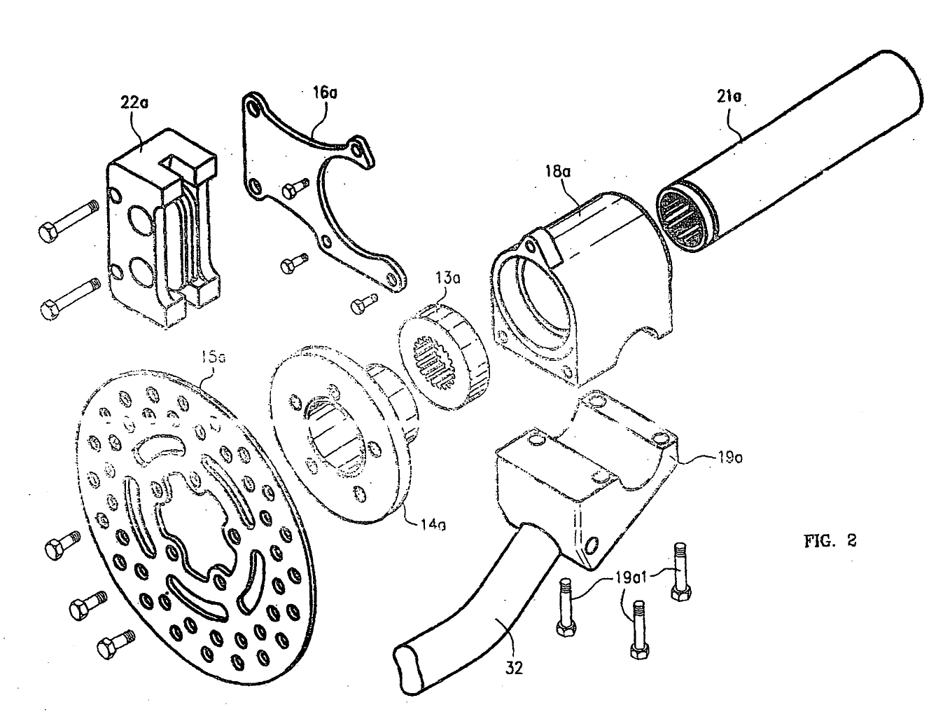

The complete wheelchair inboard disk brakes of the present invention are shown in top plan view in FIG. 1, and a portion of the disk brakes associated with the braking of on wheel is shown in perspective view in FIG. 2.

The inboard disk brake system 1 is mounted to the frame 41 of a wheelchair 4. Only such portions of the wheelchair 4 as serve to mount its inboard disk brakes appear within FIGS. 1 and 2. In general the volume shown is below the seat (not shown) of the wheelchair 4, which seat may typically mount atop the four seat stanchions, or posts, 42. The preferred disk brake system 1 may be installed at time of wheelchair 4 manufacture, including as an option, or can be retroffited as a kit to most existing wheelchairs.

The disk brake system 1 is mounted to both of two substantially vertically-extending tubular members 411 of the wheelchair frame 41 by compressing these members between each of the bearing housings 18a, 18b and corresponding ones of the brackets 19a, 19b, Each bracket 19a, 19b is preferably secured to its corresponding housing 18a, 18b by threaded machine bolts, only the heads of which are shown in FIG. 1 and three (of a total four per side) of which bolts 18c are shown in FIG. 2.

Axle shafts, or simply axles, 21a, 21b pass from inboard positions connecting to rotors 15a, 15b via disk hubs 14a, 14b—one of which is shown in detail in FIG. 2—through the bearing housings 18a, 18b to extend outward, and to locations outside or, or “outboard to” the wheelchair frame 41. These extension of the two axles 21a, 21b are located at opposite ends of the disk brake system 1. In these regions the axles 21a, 21b rigidly mount the hubs 42a1 and 42b1 of the two wheels (not shown) of the wheelchair 4. In other words, the axles 21a, 21b turn with the hubs 42a1 and 42b1, and with the two wheels (not shown) of the wheelchair 1 (partially shown only).

Brackets 16a and 16b—one of which is shown in detail in FIG. 2—support the disk brake calipers 22a, 22b—one of which is shown in detail in FIG. 2—which act through pads (not shown) in a normal manner to compress against rotors 15a, 15b when actuated. Actuation is preferably provided through hydraulic lines 28a, 28b from one or more levers 29a, acting upon a hydraulic compression cylinders within one or more assemblies 30a. Mechanical linkages, normally cables, may alternatively be used.

Both lever 29a and hydraulic cylinder assembly 30a are mounted upon to the wheelchair frame 41, normally in outside positions where at least the lever 29a is convenient to the hands of the wheelchair occupant. Sometimes the lever 29a may alternatively be mounted at the end of the wheelchair's arms (not shown). Both the lever 29a and the hydraulic cylinder assembly 30a are conventionally retained to the frame 41 of the wheelchair 4 by action of one or more brackets (which brackets may optionally be unified into a single bracket, not shown). The one or more levers 29a, and associated one or more hydraulic cylinders 30a, so mounted are selectively actuated by an occupant of the wheelchair so as to produce hydraulic pressure in the wheelchair disk brakes. The one or more levers 30a may be mounted in a position at one, or at both, or the arms (not shown) of the wheelchair 4 where they may be conveniently accessed, and activated, by either, or by both, hands of an occupant of the wheelchair 4.

Thus, in summary, it may be recognized that various portion of the wheelchair disk brakes 1 (I) clamp to a wheelchair 4 in portions of its frame 41 that are most commonly located below a seat (not shown), (ii) affix to hubs 42a1, 42b1 of the wheels (not shown) of the wheelchair 4, with an actuating lever and assembly (iii) again mounting to the frame 41 (including potentially aside the seat, or even at or near the ends of one or both of the wheelchair arms, all of which are not shown). These mountings are preferably by such compressive clamps, and clamping, as require neither drilling or any other permanent modification of the components, including the frame 41, of the wheelchair 4. The disk brakes 1 may thus be mounted to an existing wheelchair as a retrofit kit primarily by use of hand tools such as sockets, wrenches and pliers, and may be removed, and the wheelchair restored to former condition, if desired.

In further structure of the wheelchair disk brakes 1, the bottom brackets 19a, 19b—of portion of which bracket 19a is seen in detail in FIG. 9—are connected by a strut 32, which is commonly a steel tube.

During operation of the disk brakes 1, the each axle shaft, or axle, 21a, 21b—the axle shaft 21a being seen in detail in FIG. 2—rotates with the corresponding wheel (not shown) to which it is affixed, and rotates within the corresponding bearing block 18a, 18b—the bearing block 18a being seen in detail in FIG. 2. As spaced apart from each rotor 15a, 15b, by an associated caliper spacer—a one caliper spacer 13a which is shown in FIG. 2—the rotating axles 21a, 21b cause the rotors 18a, 18b to rotate within the calipers 22a, 22b. Applying hydraulic force to the calipers 22a, 22b causes moveable pistons therein to constrict against the rotating rotors 18a, 18b in the normal function of a disk brake, and, by retarding rotation of these rotors, to ultimately retard the rotation of the wheels (not shown) to which these rotors are rotationally coupled.

Thus the inboard disk brake system 1 serves to retard rotation, and thus to brake rolling motion, of each wheelchair wheel. If but one actuating lever 19a and associated hydraulic assembly 30a are used—as illustrated in FIG. 1—then the rotational retarding force to each wheel will be roughly equal. Two actuating levers like actuating lever 19a and two associated hydraulic assemblies like hydraulic assembly 30a may alternatively used to provide independent disk braking force to each wheel (not shown) of the wheelchair 4.

In accordance with the preceding explanation, variations and adaptations of the wheelchair inboard disk brakes in accordance with the present invention will suggest themselves to a practitioner of the mechanical design arts.

For example, a mechanical linkage could replace the preferred hydraulic lines for actuation of the calipers, and the disk brakes.

In accordance with these and other possible variations and adaptations of the present invention, the scope of the invention should be determined in accordance with the following claims, only, and not solely in accordance with that embodiment within which the invention has been taught.

What is claimed is:

1. A wheelchair comprising:
a frame;
wheels outboard of the frame; and
disk brakes inboard of the frame.

2. The wheelchair according to claim 1 further comprising:
an axle affixing each wheel; and
a pillow block affixed to the frame for supporting each axle;
wherein the disk brakes inboard of the frame comprise:
a rotor affixed to each axle on the opposite side of a pillow block to where is located the wheel; and
a caliper affixed to the frame and passing each rotor for selectively retarding a rotation thereof.

3. The wheelchair according to claim 2
wherein the caliper is hydraulically actuated.

4. The wheelchair according to claim 2
wherein each caliper is separately hydraulically actuated.

5. Wheelchair disk brakes having both disk rotors and disk calipers for use in retarding rotation of wheels that fixedly attach axles passing through pillow blocks affixed to the wheelchair frame in order to support rolling motion of a wheelchair, the wheelchair disk brakes CHARACTERIZED IN THAT
the disk rotors and disk calipers are located inboard of the axle hubs.

6. The wheelchair disk brakes according to claim 5 FURTHER CHARACTERIZED IN THAT
the disk calipers are hydraulically actuated.

7. The wheelchair disk brakes according to claim 6 FURTHER CHARACTERIZED IN THAT
separate disk calipers for each disk and each wheel are separately hydraulically actuated.

8. In a wheelchair having a frame and
two wheels each having a wheel hub, each wheel at its hub affixing
an associated axle shaft, each axle shaft passing through
an associated pillow block, each pillow block affixed to the frame of the wheelchair,
an improvement comprising:
a rotor fixedly mounted to each axle shaft on an opposite side of each pillow block to where exists an associated wheel; and
a caliper selectively retarding rotation of each rotor, and thus a shaft to which the rotor is affixed, and thus a wheel to which the shaft is affixed.

9. The improvement to a wheelchair according to claim 8 wherein each caliper is hydraulically actuated.

10. The improvement to a wheelchair according to claim 8 wherein each caliper is separately hydraulically actuated.
